(19) United States
(12) Patent Application Publication
(10) Pub. No.: US 2009/0074902 A1
(43) Pub. Date: Mar. 19, 2009

(54) DOUGH PRESS AND DOUGH LOADING SYSTEM

(76) Inventor: James L. Schultz, Palos Heights, IL (US)

Correspondence Address: GREER, BURNS & CRAIN, 300 S WACKER DR, 25TH FLOOR, CHICAGO, IL, 60606, US

(21) Appl. No.: 11/854,889

(22) Filed: Sep. 13, 2007

(51) Int. Cl. A21C 9/08

(52) U.S. Cl. 425/371; 99/485

(57) ABSTRACT

A press for flattening dough pieces comprising a frame supportable on a floor of a workplace, a moving conveyor belt connectable to said frame, a loading system for releasing the dough pieces loaded onto a moving upper surface of said conveyor belt, the dough pieces being released onto said upper surface essentially simultaneously as a matrix unit of multiple rows and multiple columns and at least one vertically and horizontally movable platen carried on said frame and positioned to compressingly engage the dough pieces.

### BACKGROUND OF THE INVENTION

The present invention relates to presses used to flatten dough materials formed in pieces, for example edible dough materials used in tortillas, pizzas and similar food items.

Presses for dough materials are well known in the art. One type of press comprises an automated dough press which typically has a moving belt and a vertically reciprocating platen. Generally, the belt is stopped, and while stopped the platen moves downwardly to engage and flatten dough pieces against the belt and then the platen moves upwardly. Subsequently the belt indexes to the next position to present a new series of dough pieces to the platen. While such an operation greatly increases the speed at which the dough pieces can be flattened into disk, such as tortilla and pizza shapes, the intermittent movement of the belt places a restriction on a speed at which the overall operation can be carried out, and the starting and stopping of the belt causes other difficulties relating to timing, energy requirements, wear and tear on the equipment, as well as movement of the dough pieces relative to the belt.

Another approach to flattening dough pieces is a continuously moving belt for receiving and carrying the dough pieces into a press area and from the press area to a point of further utilization. Vertically reciprocating platens are used to press the dough pieces into flattened shapes and platens can be heated so as to provide heat into the dough product.

To allow both the vertically reciprocating platen and the continuously moving belt, the platens themselves are horizontally reciprocating such that as they move together and press the dough pieces onto the belt, the platens move in the same direction and at the same speed as the belt itself. When the step of pressing, and optionally heating, is completed, the platens move away from the belt and are moved linearly backwards relative to the motion of the belt. This occurs so that the platens are in a position over a new set of dough pieces to be flattened. At this point, the platens reverse direction again and will accelerate up to the same speed in the same direction as the belt while the pressing occurs.

In the reciprocating head press a dough loading apparatus feeds dough balls through drop tubes to rotatable pocket wheels, which are aligned along their axis of rotation. The rotatable pocket wheel has pockets that receive the dough balls from the drop tubes. Upon rotation of the rotatable pocket wheel, a single dough ball is released each time the pocket rotates to a release position and loads the dough ball onto the endless conveyor belt. In this manner, each rotatable pocket wheel provides a continuous column of dough balls that are spaced from one another based on the speed of the endless conveyor belt and the rotational speed of the rotatable pocket wheel. Since multiple rotatable pocket wheels are aligned along the axial direction, the rotation of multiple rotatable pocket wheels enables a single row of dough balls to be released onto the endless conveyor belt at a time. The single row dispensing of the dough balls presents a limitation on the speed at which dough balls can be processed with such a loading system.

### SUMMARY OF THE INVENTION

The present invention provides an apparatus for releasing dough pieces onto a moving conveyor belt and pressing the dough pieces. Dough pieces can be pressed to obtain circular or other desired shapes, and heating of the dough while pressing can occur. The present invention allows for continuous operation, and particularly with the belt carrying the dough pieces, and avoids the problems associated with various approaches known in the art.

In one embodiment of the invention, a press for flattening dough pieces is provided to deposit dough balls precisely onto a moving conveyor belt, at the same speed as the moving belt to avoid the necessity of flattening the dough balls to prevent their movement relative to the belt of the conveyor or to require that the speed of the belt be changed. Additionally, the dough balls are released as a matrix unit of multiple rows and multiple columns so as to release more dough balls onto the belt in a given time period as compared to conventional single row dough ball loading systems.

In an embodiment of the invention, a loading system for releasing dough pieces onto a moving conveyor belt is provided. The loading system includes a plurality of drop guides with lower ends positioned above the conveyor. The lower ends are positioned in an array of a plurality of rows and a plurality of columns.

In an embodiment, the drop guides have open top ends for receiving dough pieces from a proofing conveyor.

In an embodiment, the lower ends comprise a positioning element to position the dough piece on the conveyor.

In an embodiment, the drop guides comprise a plurality of drop tubes.

In an embodiment, a reciprocating slide gate is connected to the drop guides.

In an embodiment, the reciprocating slide gate comprises at least one plate member having a series of plate regions and openings such that the dough pieces can be captured on the plate regions and released to the conveyor through the openings.

In an embodiment, the reciprocating slide gate is configured to reciprocate in a first direction along a direction of movement of the conveyor belt to release the dough pieces onto the conveyor.

In an embodiment, the reciprocating slide gate has a planar surface provided with an anti-stick coating.

In an embodiment, the loading system includes a plurality of upper pivot knuckles, each upper pivot knuckle connected to an upper end of a respective drop guide, and a plurality of lower pivot knuckles, each lower pivot knuckle connected to a lower end of a respective drop guide.

In an embodiment, the upper pivot knuckles are pivotable about a first axis and rotatable about a second axis.

In an embodiment, the lower pivot knuckles are pivotable about a first axis and rotatable about a second axis.

In an embodiment, an actuating mechanism is positioned along a length of each of said drop guides configured to selectively catch and release a dough piece.

In an embodiment, the actuating mechanism is positioned above each drop guide.

In an embodiment, the actuating mechanism is positioned below each drop guide.

In an embodiment of the invention, a press for flattening dough pieces is provided. The press includes a frame supportable on a floor of a workplace. A moving conveyor belt is connectable to the frame. A loading system is provided for releasing the dough pieces loaded onto a moving upper surface of the conveyor belt, the dough pieces being released onto the upper surface as a matrix unit of multiple rows and multiple columns. At least one movable platen is carried on the frame and positioned to compressingly engage the dough pieces.

In an embodiment of the invention, a loading system is provided for loading pieces onto a moving conveyor belt. The loading system includes a plurality of receiving receptacles for accepting a plurality of dough pieces to be loaded onto the moving conveyor belt. Each of the receptacles is provided with a release mechanism to permit essentially simultaneous loading of a plurality of dough pieces in an array of a plurality of rows and a plurality of columns on the conveyor.

### BRIEF DESCRIPTION OF THE DRAWINGS

FIG. 1 is a schematic side elevation view of a dough processing system incorporating a press embodying the principles of the present invention.

FIG. 2 is a schematic view of a control system for the press and loading system.

FIG. 3 is a schematic side elevation view of the press and loading system embodying the principles of the present invention.

FIG. 4 is a side elevation view of the loading system shown in isolation.

FIG. 5 is an end elevation view of the loading system of FIG. 4.

FIG. 6 is a plan view of a slide gate plate member.

FIG. 7 is a perspective view of a bird beak mechanism in isolation in a close position.

FIG. 8 is a perspective view of a bird beak mechanism in isolation in an open position.

### DETAILED DESCRIPTION OF THE PREFERRED EMBODIMENTS

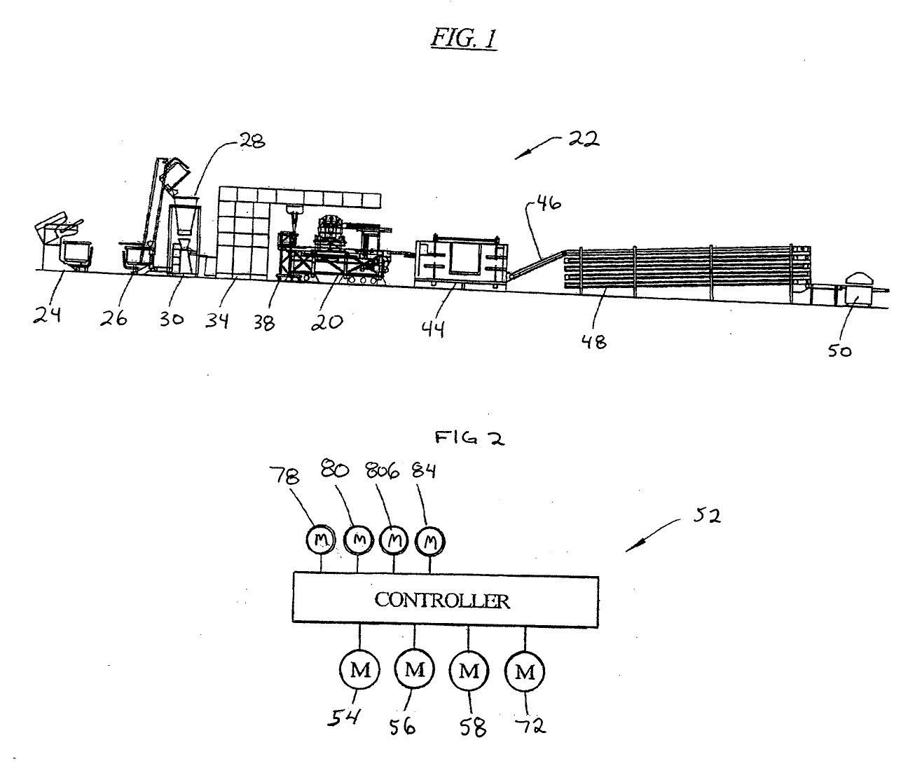

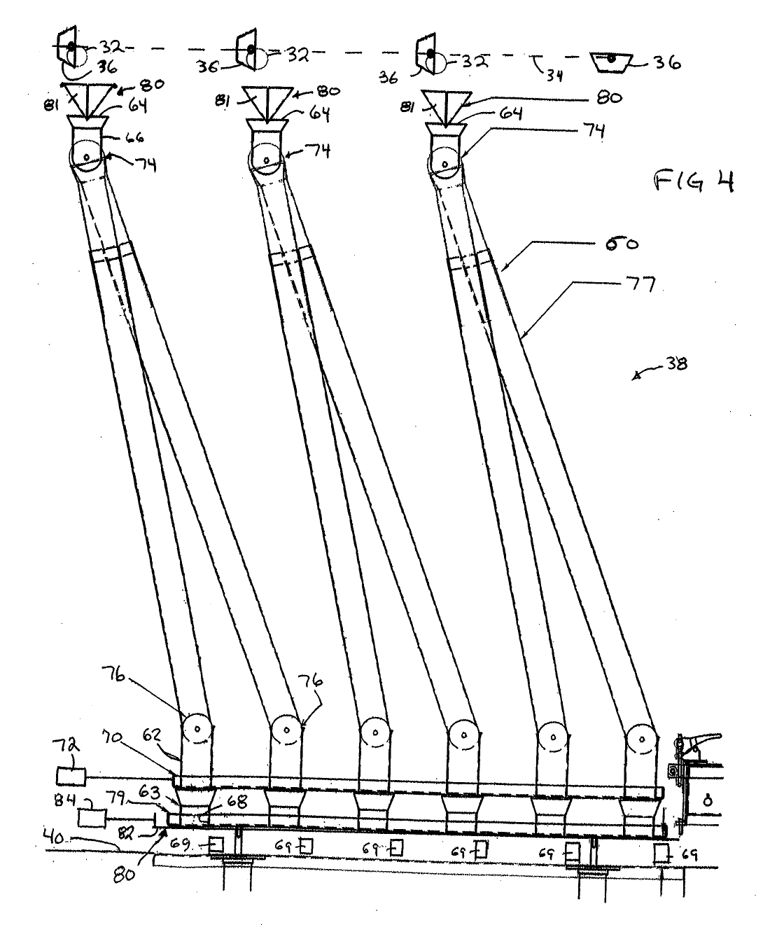

The present invention relates to a press 20 for flattening dough pieces, for example, flattening dough pieces, such as dough balls, into pancake like shapes for tortillas, pizza crusts and similar food products. Because of the high rates that dough pieces can be processed through the press 20, the press is typically arranged in a system 22 of mechanisms as illustrated schematically in FIGS. 1 and 3. This system can begin with a dough mixer 24 in which flour or a similar product is mixed with water and other ingredients according to some particular recipe to produce a large batch of dough. The mixer 24 may include an elevator 26 to raise a portion of the mixer to an elevated position where the mixed dough batch is dropped into a holding hopper and dough chunker 28. In the holding hopper and dough chunker 28 the batch of dough is held and then chunks of dough are dispensed into a dough divider and rounder 30 in which the dough is divided into much smaller portions and is rounded into ball shapes. The rounder 30 then feeds individual dough balls 32 to a proofer 34 where the dough balls are held at a predetermined temperature and humidity for a prescribed length of time, such as by moving along a conveyor traveling through the proofer where the dough balls are held in individual pockets or trays 36 in the proofer.

At the end of the proofing time, a series of dough balls 32 are dispensed through a dough loading apparatus 38 to a continuous conveyor belt 40 carried on a floor supported frame 41 of the press 20, such as the press incorporating the principles of the present invention. In the press 20, the individual dough balls 32 are pressed between vertically opposed platens 42 carried on the press frame 41 while the dough balls are carried on the movable endless conveyor belt 46, all as described in more detail in U.S. Pat. No. 6,951,451, which is incorporated herein by reference. When the dough balls 32 have been flattened into pancake-like shapes, they are dispensed from the end of the press 20 to an oven 44 where the dough products are partially or fully baked. Following the baking process, the dough pieces move on a conveyor 46 to a cooling conveyor 48 from where they are moved to a packing system 50 or storage area.

The upper and lower platens 42 can reciprocably move longitudinally relative to the press 20, that is, in the direction of the moving conveyor belt 40, such that while the platens are engaging and pressing the dough balls 32, the platens move in the same direction and at the same speed as the moving conveyor belt thereby allowing the belt to continue in its movement without slowing or stopping.

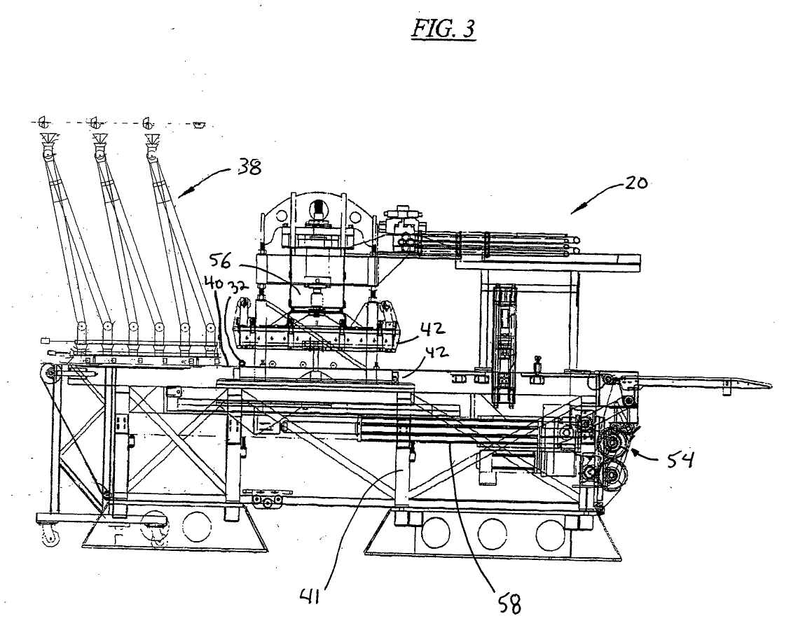

A control 52 (FIG. 2) is provided for operating a drive mechanism 54 for the conveyor belt 40, as well as a vertical drive mechanism 56 for the platens. A horizontal drive mechanism 58 for the platens 42 is also operated by the control 52.

The present invention provides an improved loading apparatus 38 for releasing dough pieces onto the conveyor belt 40. As mentioned above, the dough pieces 32 may be rounded into balls. They also may be formed in other shapes. However, in the illustrated embodiment a dough rounder 30 is contemplated, so the dough pieces 32 will be referred to as dough balls, even though the present invention contemplates dough pieces of other shapes.

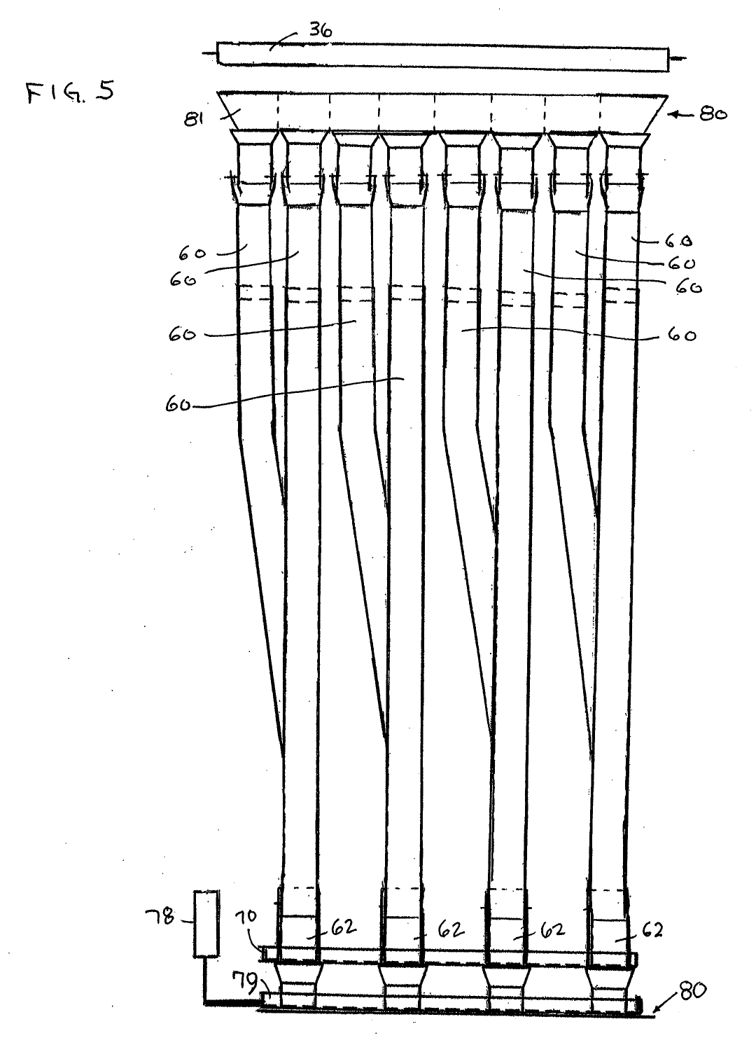

In an embodiment of the invention as shown in FIGS. 4 and 5, the loading apparatus 38 includes a plurality of receiving receptacles 59 in the form of drop guides 60 with lower ends 62 positioned above the conveyor belt 40. The lower ends 62 are positioned in an array of a plurality of rows and a plurality of columns. Each row extends laterally across a width of the conveyor belt 40, and each column extends longitudinally along the length direction of the conveyor belt, parallel to its direction of movement.

The lower ends 62 may be positioned over funnel cups 63, with a separate funnel cup provided for each drop guide 60. In other embodiments, the lower ends 62 may terminate just above the conveyor belt 40 without utilizing separate funnel cups 63.

In an embodiment, the drop guides 60 have open top ends 64 for receiving dough balls 32 from the proofing conveyor 34. In other embodiments, the drop guides 60 may have openings near, but not at the top ends 64, such as through a side 66 of the drop guide, or the top ends 64 may be normally closed, and selectively openable to receive the dough balls 32.

In an embodiment, the lower ends 62 comprise a positioning element 68 to position the dough ball 32 on the conveyor belt 40. The positioning element 68 may comprise a wall portion of the lower end 62 or funnel cup 63, or a separate structure. For example, aligning bars 69 extending across the width of the conveyor belt 40 to engage the dough balls 32 from several laterally adjacent drop guides 60 may be used as the positioning element 68. Such aligning bars can be selectively raised and lowered relative to the conveyor belt 40 by the control 52 to release or capture each row of dough balls present on the conveyor belt.

In an embodiment, the drop guides 60 comprise a plurality of drop tubes. The drop tubes 60 may have a circular or rectangular cross sectional shape, or may be formed in other shapes. In other embodiments, the drop guides 60 may comprise structures other than tubes, such as spaced elongated slats or wires defining a central longitudinal passage for the dough balls 32. In the illustrated embodiments, the drop guides 60 are shown as tubes and will be referred to herein as drop tubes, even though other types of drop guides may be utilized in accordance with the invention.

The drop tubes 60 may be provided in sets, with each set comprising a plurality of such drop tubes arranged across the width of the conveyor belt 40 to load one or more rows of dough balls 32 onto the conveyor belt at a time. For example, in FIG. 5, there are shown to be eight drop tubes 60 arranged laterally next to one another. These eight drop tubes 60 may receive eight separate dough balls from the proofing tray 36 essentially simultaneously. Four of the drop tubes 60 are shown to be substantially straight. Another four of the drop tubes 60 have a slight double bend in them, allowing for those four drop tubes to have their lower ends 62 arranged longitudinally in line with the lower end of one of their neighbors, resulting in two separate rows of four dough balls each (see FIG. 4), to be arranged on the conveyor belt essentially simultaneously. The drop tubes 60 may be shaped differently than shown, such as by having all of the tubes shaped identically with slight bends in each to accommodate multiple rows of lower ends 62 from a single row of upper ends. Of course, each set of drop tubes 60 might provide only a single row of dough balls 32 on the conveyor belt 40, or more than two rows.

In this specification, the term “essentially simultaneously” means that the dough balls 32 are released as a group or batch at nearly the same time, rather than sequentially, one row after the other. Due to the nature of the dough products being acted upon, there may be some sticking or adherence that occurs, preventing all of the dough balls 32 from moving exactly simultaneously, even though they do move generally as a group, rather than in subsequent steps. Such movement as a group or batch is encompassed by the phrase “essentially simultaneously.”

The lower ends 62 of the drop tubes 60, in an embodiment, are secured, relative to one another, by a frame 70 or similar structure, such that the spacing between the lower ends of adjacent drop tubes will remain fixed. The frame 70 is driven by a horizontal frame drive mechanism 72 operated by the control 52 to move in a horizontally reciprocating manner so that during a portion of its movement during a loading cycle, the frame is moving at the same speed and in the same direction as the conveyor belt.

The frame 70 may be horizontally driven via a variety of mechanisms 72. For example, a motor may be used to rotate a pinion portion of a rack and pinion drive. A screw may be rotated in a traveling nut drive. A pneumatic or hydraulic piston may be used. A linear actuator may also be used. In any event, the horizontal frame drive mechanism 72 is capable of moving the frame 70 carrying the lower ends 62 of the drop tubes 60 in a controlled fashion in a horizontal direction parallel to the direction of movement of the conveyor belt 40. Alternatively, the frame 70 may be coupled to the horizontal drive mechanism 58 for the platens 42 so that the frame will move longitudinally in tandem with the platens.

At other portions of the loading cycle, the frame 70 is driven in an opposite direction. In this manner, the drop tubes 60 will undergo a back and forth swinging movement while the conveyor belt 40 undergoes a continuous constant speed movement in a single direction.

To allow the drop tubes 60 to undergo the swinging movement, the top end 64 of each drop tube includes a knuckle 74 that permits pivoting movement about a horizontal axis, as well as a twisting or rotating movement about the longitudinal axis of the drop tubes. A second, lower knuckle 76 may be provided on each drop tube 60 to permit the lower end 62 to remain in an essentially vertical orientation while a middle portion 77 of the drop tubes swings through various angles relative to vertical. The lower knuckle 76 may also allow for pivoting movement about a horizontal axis, as well as a twisting or rotational movement about the longitudinal axis of the drop tube 60. The drop tubes 60 are also assembled in a telescoping manner such that the lower ends 62 of the drop tubes can be moved vertically relative to the top ends 64, as needed during the loading cycle, such as to accommodate the swinging motion while maintaining the lower ends 62 a fixed distance above the conveyor belt 40. To effect the vertical movement of the lower ends 62 of the drop tube 60, the frame 70 can be driven by a vertical frame drive mechanism 78 operated by the control 52 to move in a vertically reciprocating manner, independently of the horizontal reciprocation of the frame.

The frame 70 may be vertically driven via a variety of mechanisms 78. For example, a motor may be used to rotate a pinion portion of a rack and pinion drive. A screw may be rotated in a traveling nut drive. A pneumatic or hydraulic piston may be used. A linear actuator may also be used. In any event, the drive mechanism is capable of moving the frame 70 carrying the lower ends 62 of the drop tube 60 in a controlled fashion in a vertical direction perpendicular to the direction of movement of the conveyor belt 40. In those systems utilizing funnel cups 63, the lower ends 62 may remain at a fixed distance above the conveyor belt 40, with the funnel cups being raised and lowered by the vertical frame drive mechanism 78 acting on a separate frame 79 holding the funnel cups.

In order to place an array of rows and columns of dough balls 32 onto the conveyor belt 40, essentially simultaneously, the proofer tray 36 carrying the plurality of dough balls 32 may be tipped to drop the dough balls into the open top ends 64 of the drop tubes 60. In one embodiment, an actuating mechanism 80, which may comprise a separate bird beak capture and release mechanism 81 for each drop tube 60, may be provided to capture a dough ball 32 above each drop tube, and then to release the dough ball essentially simultaneously with each of the other bird beak mechanisms as operated by the control 52. This arrangement can be used to assure that the dough balls 32 will begin their drop through the drop tubes 60 essentially simultaneously, to overcome any sticking or other delay in the release of the dough balls from the tray 36, or to allow multiple trays to be used to fill the bird beak mechanism 81 in a non-simultaneous manner.

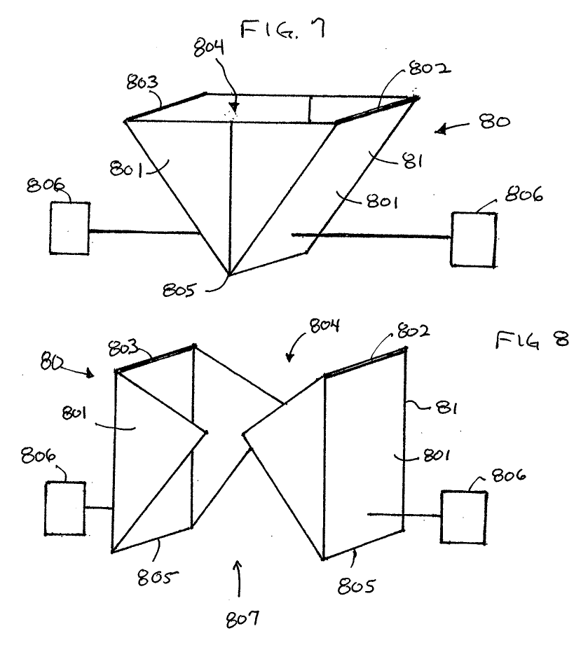

The bird beak mechanism 81 (shown in isolation in FIGS. 7 and 8) comprises a pair of opposed members 801 pivotable about axes 802 and 803 that can be urged towards each other to present an open top end 804 and a closed bottom end 805 (FIG. 7). The members 801 can be pivoted away from each by an operating mechanism 806 controlled by the control 52 such that the bottom end 805 opens (FIG. 8), providing an open passage 807 for the dough balls 32 to fall through.

Other simultaneous drop arrangements may be provided in accordance with the scope of this invention. For example, an actuating mechanism 80 may positioned along a length of each of the drop tubes 60 configured to selectively catch and release a dough ball 32. The actuating mechanisms 80 may be operated by the control 52 essentially simultaneously to release the dough balls 32 to fall onto the conveyor belt 40. In an embodiment, the actuating mechanism 80 may be positioned above each drop tube 60, as illustrated by the bird beak mechanisms 81. Other capture and release mechanisms 80 may be provided above the drop tubes 60, such as slide plates, pivoting doors or fingers, rotating wheels or paddles, etc.

In an embodiment, the actuating mechanism 80 is positioned below each drop tube 60.

An example of this arrangement is discussed below, but also in this area below the drop tube 60, each of the above described types of actuating mechanisms 80 may be utilized.

In an embodiment, there may be an actuating mechanism 80 positioned both above and below each drop tube 60. The upper and lower actuating mechanisms 80 may be the same type of construction, or may differ from each other.

Once the dough balls 32 are released to begin their fall through the drop tubes 60, they will arrive at the lower ends 62 of the drop tubes essentially simultaneously. The lower ends 62 of the drop tubes 60 (or the funnel cups 63) can be moved vertically, and when the dough balls arrive at the lower ends or shortly thereafter, the lower ends 62 may be positioned very close to the conveyor belt 40. In some embodiments, the lower ends 62 are open, and the dough balls 32 merely fall through the lower ends and onto the conveyor belt 40. In other embodiments, the lower ends 62 may be provided with the actuating mechanism 80 to first catch and hold the dough balls 32, and then to release the dough balls essentially simultaneously with all of the other dough balls held at the lower ends.

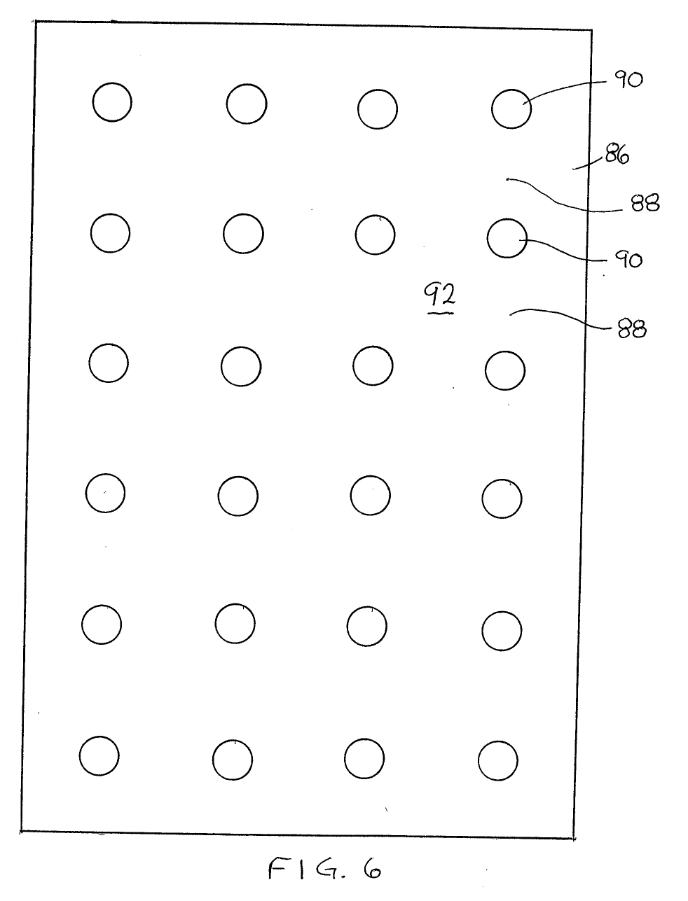

For example, a reciprocating slide gate 82 may be connected to the drop tubes 60 such as below the open lower ends 62. The reciprocating slide gate 82 may be driven by a horizontal slide gate drive mechanism 84 operated by the control 52 and may comprise at least one plate member 86 (FIG. 6) having an alternating series of solid plate regions 88 and openings 90 such that the dough balls 32 can be captured on the plate regions and released to the conveyor belt 40 through the openings when the slide gate is moved to align the openings with the lower ends 62 of the drop tubes 60. In an embodiment, the reciprocating slide gate 82 has an upper planar surface 92 provided with an anti-stick coating which stops and holds the dough balls 32 prior to allowing them to drop onto the conveyor belt 40.

The slide gate 82 may be horizontally driven via a variety of mechanisms 84.

For example, a motor may be used to rotate a pinion portion of a rack and pinion drive. A screw may be rotated in a traveling nut drive. A pneumatic or hydraulic piston may be used. A linear actuator may also be used. In any event, the drive mechanism 84 is capable of moving the slide gate in a controlled fashion in a horizontal direction parallel to the direction of movement of the conveyor belt 40.

In an embodiment, the reciprocating slide gate 82 is configured to reciprocate in a first direction along a direction of movement of the conveyor belt 40 to capture or release the dough balls 32. The first direction of movement of the slide gate 82 could alternatively be perpendicular to the direction of movement of the conveyor belt 40 (or at some angle other than perpendicular), yet parallel to the surface of the conveyor belt. As discussed below, the slide gate 82 may also move vertically with the frame 70, and may be used to compressingly engage the dough balls 32 after they have been loaded onto the conveyor belt 40.

In an exemplary embodiment in a continuous moving belt press 20, the proofer trays 36 are arranged to drop a plurality of dough balls 32 into the top open ends 804 of a plurality of bird beak mechanisms 81 positioned above the open top ends 64 of the drop tubes 60. The bird beak mechanisms 81 are controlled to simultaneously open, causing the dough balls 32 to fall through the drop tubes 60 to the lower ends 62 where they land on the plate region 88 of the reciprocating slide gate 82 positioned just below the bottom of the lower ends of the drop tubes. The drop tubes 60 are swung by the horizontal reciprocating drive 72 of the frame 70 (or by being attached in tandem with the platens 42) such that the lower ends 62 are moving in the same direction and at the same speed as the conveyor belt 40. The frame 70 securing the lower ends 62 is lowered by the vertical reciprocating drive 78 such that the lower ends are positioned just above the conveyor belt 40.

The slide gate 82 is then moved by the horizontal reciprocating slide drive 84 so that the openings 90 in the plate member 86 align with the open ends of the lower ends 62, and the dough balls 32 drop onto the conveyor belt 40 in a matrix of rows and columns. The walls of the lower ends 62 hold the dough balls 32 in a fixed alignment position on the conveyor belt 40 as the frame 70 is lifted up and away from the conveyor belt by the vertical reciprocating drive 78. Once the slide gate 82 has vertically cleared the top of the dough balls 32, the slide gate is horizontally moved so that the solid plate region 88 of the slide gate is positioned above the dough balls. The frame 70 is then lowered so that the plate member 86 will engage an upper surface of the dough balls 32 to slightly flatten the dough balls on the conveyor belt 40, to assure that the dough balls will not move relative to the conveyor belt. The frame 70 will then move vertically, and will begin to slow down relative to the forward movement of the conveyor belt 40, until the frame begins a rearward movement to position the lower ends 62 of the drop tubes 60 at a different location on the conveyor belt. As the frame 70 begins this movement away from the position of the placed dough balls 32, the next set of dough balls can be dropped by the proofer trays 36 or bird beak mechanisms 81 to begin the movement of the next group of dough balls towards the conveyor belt 40.

The timing of the tipping of the proofer trays 36, the opening of the bird beak mechanisms 81, the swinging of the drop tubes 60, the horizontal reciprocation and vertical reciprocation of the frame 70, and the opening and closing of the slide gate 82 can all be adjusted in the control 52 such that the array comprising a plurality of rows and columns of dough balls 32 can be delivered to the conveyor belt 40 essentially simultaneously and at the same horizontal speed that the conveyor belt is moving.

In an embodiment, as shown in FIG. 4, a plurality of sets of drop tubes 60 can be provided, such as the three separate rows of top openings 64 leading to six rows of lower ends 62, such that a larger number of dough balls 32 can be placed onto the conveyor belt as a batch essentially simultaneously. A next subsequent batch of dough balls 32 comprising a plurality of rows and columns can be placed onto the conveyor belt 40 directly following the prior batch such that a spacing between a first row of a subsequent batch and a last row of a previous batch is identical to a spacing between adjacent rows of each batch. In this manner, the finished flattened dough pieces 32 coming out of the press 20, and being delivered to the oven 44 will present a constant heat absorbing load into the oven, and subsequently into the packing system 50, so that no special conveyor systems are required to even out the spacing between adjacent batches of dough pieces.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

I claim as my invention:

1. A loading system for releasing dough pieces onto a moving conveyor belt comprising:
a plurality of drop guides with lower ends positioned above said conveyor, said lower ends being positioned in an array of a plurality of rows and a plurality of columns and arranged to be reciproctably movable in a direction of movement of said belt.

2. The loading system of claim 1, wherein said drop guides have open top ends for receiving dough pieces from a proofing conveyor.

3. The loading system of claim 1, wherein said lower ends comprise a positioning element to position said dough piece on said conveyor.

4. The loading system of claim 1, wherein said drop guides comprise a plurality of drop tubes.

5. The loading system of claim 4, wherein each of said drop tubes comprises a telescoping sleeve.

6. The loading system of claim 1, further comprising:
a plurality of upper pivot knuckles, each upper pivot knuckle connected to an upper end of a respective drop guide; and
a plurality of lower pivot knuckles, each lower pivot knuckle connected to a lower end of a respective drop guide.

7. The loading system of claim 6, wherein said upper pivot knuckles are pivotable about a first axis and rotatable about a second axis.

8. The loading system of claim 6, wherein said lower pivot knuckles are pivotable about a first axis and rotatable about a second axis.

9. The loading system of claim 1, further comprising an actuating mechanism positioned along a length of each of said drop guides configured to selectively catch and release a dough piece.

10. The loading system of claim 9, wherein said actuating mechanism is positioned above each drop guide.

11. The loading system of claim 10, wherein the actuating mechanism comprises a bird beak mechanism.

12. The loading system of claim 9, wherein said actuating mechanism is positioned below each drop guide.

13. The loading system of claim 12, further comprising a reciprocating slide gate connected to said drop guides.

14. The loading system of claim 13, wherein said reciprocating slide gate includes a horizontal reciprocating slide drive and comprises at least one plate member having a series of solid plate regions and openings such that the dough pieces can be captured on the plate regions and released to said conveyor through said openings.

15. The loading system of claim 14, wherein said reciprocating slide gate is arranged to reciprocate in a first direction along a direction of movement of said conveyor belt to release said dough pieces and in a second, perpendicular direction to compressingly engage the dough pieces loaded onto said conveyor.

16. The loading system of claim 13, wherein said reciprocating slide gate has a planar upper surface provided with an anti-stick coating.

17. A press for flattening dough pieces comprising:
a frame supportable on a floor of a workplace;
a moving conveyor belt connectable to said frame;
a loading system for releasing the dough pieces loaded onto a moving upper surface of said conveyor belt, the dough pieces being released onto said upper surface essentially simultaneously as a matrix unit of multiple rows and multiple columns while the belt is moving; and
at least one vertically and horizontally movable platen carried on said frame and positioned to compressingly engage the dough pieces.

18. A loading system for loading pieces onto a moving conveyor belt comprising:
a plurality of receiving receptacles for accepting a plurality of dough pieces to be loaded onto said moving conveyor belt, each of said receptacles being provided with a release mechanism to permit essentially simultaneous loading of a plurality of dough pieces in an array of a plurality of rows and a plurality of columns on said conveyor belt while said belt is moving.

19. The loading system of claim 18, wherein the release mechanism comprises a pivotable catch and release mechanism.

20. The loading system of claim 18, wherein said release mechanism comprises a reciprocating slide gate having a series of plate regions and openings such that the dough pieces can be captured on the plate regions and released as said array to said conveyor through said openings.
